(19) United States
(12) Patent Application Publication
(10) Pub. No.: US 2023/0017409 A1
(43) Pub. Date: Jan. 19, 2023

(54) OMNIDIRECTIONAL CONSTRUCTION SYSTEM AND CONNECTORS

(71) Applicant: Gustavo Adolfo SANTANDER LORA, Aventura, FL (US)

(72) Inventor: Gustavo Adolfo SANTANDER LORA, Aventura, FL (US)

(21) Appl. No.: 17/782,619

(22) PCT Filed: Dec. 3, 2019
(86) PCT No.: PCT/IB2019/060403

§ 371 Date: Jun. 3, 2022

(51) Int. Cl. F16B 7/18; E04B 1/19

(52) U.S. Cl. CPC F16B 7/185; E04B 1/19; E04B 2001/1963

(57) ABSTRACT

The present invention is in the field of modular structures, assembled by way of fastening or attached means, whose purpose is to be used as base support structures for various applications, particularly connecting systems involving plastic or aluminum containers, recipients, bottles or vessels. Particularly, the invention comprises an omnidirectional construction system that includes connectors and terminals to be attached to containers with threaded openings or flat openings and container bases, to which various types of connectors may be attached to.

### FIELD OF THE INVENTION

The present invention is in the field of modular structures, assembled by way of fastening or attached means, whose purpose is to be used as base support structures for various applications. In particular, connector systems involving plastic containers, containers in general, bottles, containers or cans, along with aluminum.

### BACKGROUND OF THE INVENTION

There are a variety of state-of-the-art solutions for making coupling-based structures, such as U.S. Pat. 7,644,828, which shows a container coupling system that is made up of a container that has an open upper end and a closed lower end with a chamber in between. The upper end is formed as a neck while the lower end is formed as a recess. The neck and the recess are essentially cylindrical with a common axis and a common length and diameter. The cavity, adapted to receive a neck of another similarly configured bottle/container system, the neck adapted to engage a cavity of another similarly configured bottle/container system; external male threads in the neck and internal female threads in the recess, further including a supplemental coupler adapted to releasably attach to a plurality of container systems. The supplemental coupler has a generally flat configuration, having a face and a periphery, and with at least one threaded opening through the face along with at least one threaded recess in the periphery.

U.S. Pat. 3,765,353 shows an improved method of joining elongated bottle members into a buoyancy structure. A plurality of elongated bottle members connects at a point below the waterline of the body of water in which they are floating. This joint is achieved by dewatering a volume between adjoining specially shaped sections at the lower end of the elongated bottle members and filling the dewatered joint with a plastic concrete mix. After curing the concrete, the joint is placed under a compressive load, to ensure a rigid and mechanically stable joint. If desired, a passageway may be constructed between adjacent elongated bottle members to provide a passageway between them.

U.S. Pat. 5,120,253 shows a hub joint connector comprising of six cylindrical receivers extending from the hub, into which bottle caps can be inserted and locked. The hub is constructed from an even cruciform flat piece with folding hinges between square panels, comprising the cylindrical receivers. Panels fold into a hub and lock together, using male snaps mated with female receivers. A flange that bypasses the edge of the cylinder, acting like a padlock, holds and secures the bottom of the bottle cap to the cylinder. The rivets comprise two male spring members secured together at a base, and can be divided into two parts to allow for flexibility. Rivets are used in preformed openings in the bottle bottoms and secure one bottle bottom to another bottle bottom.

International publication WO2018/222542 shows a building block system composed of a block having a first set of three faces and a second set of three faces, with the first and second sets diagonally opposite each other, where each of the first and second sets include a first connector configuration and a second connector configuration. The first connector configuration is different from the other one, and configured to interconnect with the second connector configuration, wherein the three faces of the first and second sets include three interconnecting edges at the first and second vertices, respectively diagonally opposite each other, where the first and second connector configurations, include a matrix defined by at least two rows and at least two columns of connectors, with the connectors in each row and each column of the first connection configuration comprising alternating posts and channels. The posts are configured to slideably interconnect within channels, wherein at least two rows comprise of an odd number of rows, and at least two columns comprise an odd number of columns, where each post has circular cross sections, each channel has polygonal cross sections, the three faces of the first and second sets are three flat faces extending between the three edges, where each channel is flush with a corresponding flat face. Each post has a free end, spaced from a corresponding flat face and has cross sections parallel to the corresponding flat face of the same shape from the free end to the corresponding flat face. The three faces of the first set comprise first, second and third faces, with the three edges of the first set comprising the first, second and third edges. The first and second faces are pivotally connected by the first edge, and the second and third faces interconnected by the second edge; the first and the second edges are perpendicular to each other, the first and third faces are interconnected by the third edge, the first face including a fourth edge opposite the first edge and a fifth edge opposite the second edge, the second face having a sixth edge opposite the first edge and a seventh edge opposite the second edge; the third face having an opposite eighth edge to the second edge and a ninth edge opposite the third edge, where the three faces of the second set comprise fourth, fifth and sixth faces, the fourth face interconnected to the second face by the sixth edge and interconnected to the third face by the ninth edge, the three edges of the second set comprising the tenth, eleventh, and twelfth edges, the fifth face interconnected to the fourth face by the tenth edge, the third and fifth faces interconnected by the eighth edge, with the first and fifth interconnected by the fourth edge, with the second and sixth faces interconnected by the seventh edge, the first and sixth faces interconnected at the fifth edge, with the faces fourth and sixth faces interconnected by the eleventh edge, the fifth and sixth faces interconnected by the twelfth edge, and where five of the first through twelfth edges are formed by a pivoting interface and seven of the first through twelfth edges are formed by a sliding interconnection.

The previous documents do not solve the problem of omnidirectional coupling of the structures, making it possible to execute structures in any direction in a systematic, flexible and easy way.

### SUMMARY OF THE INVENTION

An omnidirectional construction system that includes connectors and terminals for coupling containers that have threaded fittings or flat fittings and container bases, to which they can be coupled with various types of connectors.

### BRIEF DESCRIPTION OF THE DRAWINGS

The present invention will be more fully understood by reference to its following detailed description, when read in conjunction with the accompanying drawings, where the same reference numerals refer to similar elements, and where:

FIG. 1 a, b shows female threaded terminals with multiple connection directions and various connection hole sizes, with connector;

FIG. 2 a, b, shows a threaded female terminal with multiple connection directions and a simplification of the orthogonal and inclined planes where the axis of the threads can be placed perpendicular;

FIG. 3 a, b, shows a threaded female terminal with multiple connection directions with an articulated connector;

FIG. 4 a, b, shows a female terminal with a cylindrical connector and extender;

FIG. 5 a, b, c, d, shows a container coupled on both sides to a cylindrical connector and extender;

FIG. 6 a, b, c, d, shows a container coupled on both sides to a double threaded connector coupled to a female terminal;

FIG. 7 a, b, c, d, shows threaded connectors with flat intermediate support coupled to the base or opening of a container;

FIG. 8 a, b, c, d, shows threaded connectors at both ends coupling two containers at the base or at the opening;

FIG. 9 a, b, shows the detail of FIGS. 8a and 8c;

FIG. 10 a, b, c, shows a geodesic dome with female terminals coupled to articulated connectors and these to their containers;

FIG. 11 a, shows ties and their way of fastening between the containers;

FIG. 12 a, b, shows plugs and sockets attached to containers;

FIG. 13 a, b, shows how a multidirectional female terminal is attached to hinged connectors and then to a male coupling to fit a container;

FIG. 14 a, b, shows how a multi-directional female terminal is mated to threaded connectors at both ends and then to a male coupling to fit a container;

FIG. 15 a, b, shows one way of attaching a connector to an extender;

FIG. 16 a, b, c, d, shows a consolidation of the possible embodiments of the connectors;

FIG. 17 shows a schematic diagram of a system layout on a wall;

FIG. 18 shows a container arrangement;

FIG. 19 shows a container arrangement;

FIG. 20 shows an isometric view of a geodesic dome made with the omnidirectional construction system;

FIG. 21 shows a top view of a geodesic dome made with the omnidirectional construction system;

FIG. 22 shows an isometric view of an example application of the omnidirectional building system;

FIG. 23 shows an isometric view of an application example of the omnidirectional building system in a structure form;

FIG. 24 shows an isometric view of an application example of the omnidirectional construction system in the form of a truss;

FIG. 25 a, b, shows isometric views of application examples of the omnidirectional building system in the form of a roof structure.

### DETAILED DESCRIPTION OF THE INVENTION

The present invention reveals an omnidirectional constructive system and connectors, which is composed of multiple direction threaded female terminals which can be directly coupled to the openings of containers. The term containers is used broadly to describe bottles, cans, containers and other equivalents; it also has union connectors that can be coupled to the multiple direction threaded female terminals, and these also in turn can be coupled to opening or base of other containers, to form structures in any direction.

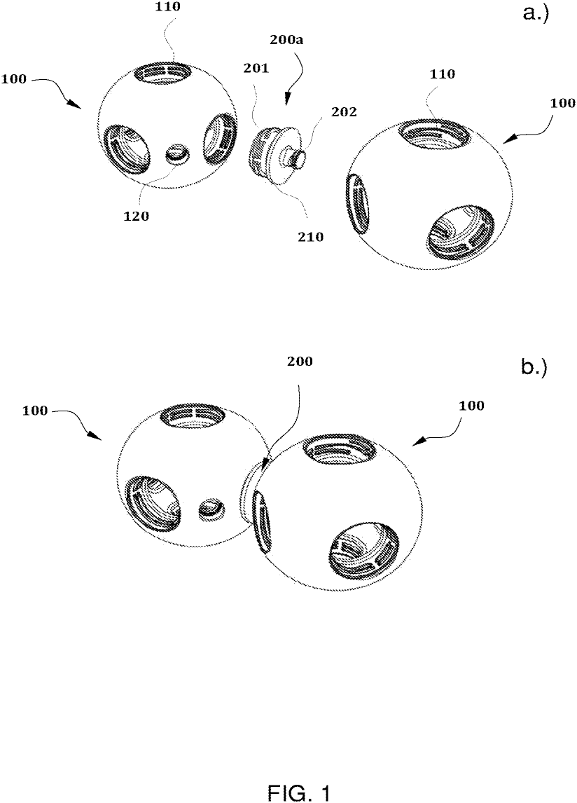

FIG. 1 parts a.) and b.) reveals multidirectional female terminals (100) connected through a connector (200a), where each multidirectional female terminal (100) has threaded holes (110) (120) of various sizes, at various locations where the longitudinal axis of each cylinder containing each thread is substantially perpendicular to the substantially tangent plane of a sphere. Connector (200a) has a first cylindrical portion (201) with at least one thread on its inner or outer surface; where the cylindrical portion (201) extends towards an intermediate base (210) that extends towards a second cylindrical portion (202) having at least one thread on its inner or outer surface; the cylindrical portion (201) (202) is hollow or solid.

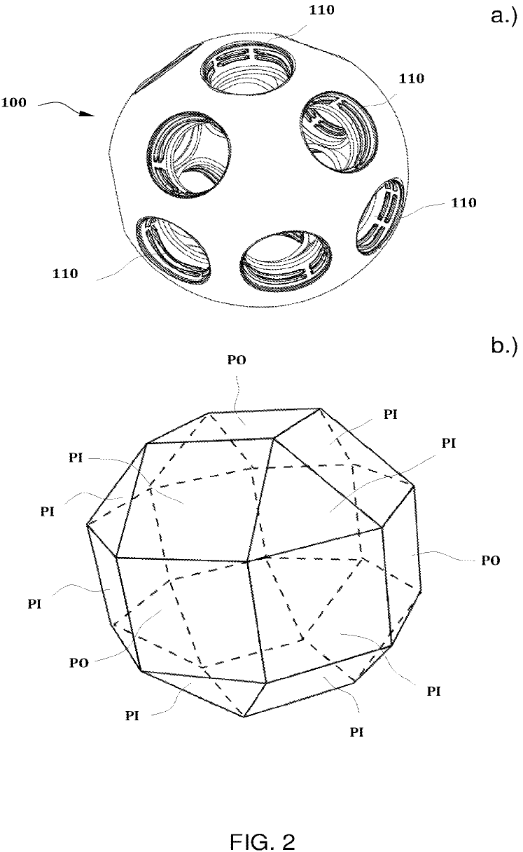

FIG. 2 part a.) reveals a multidirectional female terminal (100) with holes (110) and part b.) reveals a graphic representation of the tangential planes on which the threads are formed, where orthogonal planes (OP) may be defined. And these orthogonal planes could be the main planes and correspond top, bottom, front, back, left and right views; In addition, inclined planes (IP) are shown, which can include any angle between planes with respect to the orthogonal planes, but are preferably planes at 30°, 45° and 60° with respect to the orthogonal planes (PO).

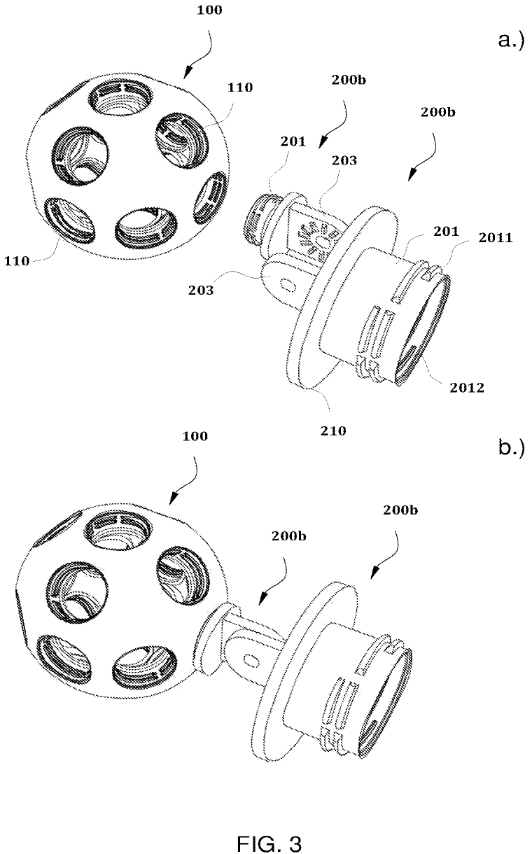

FIG. 3 parts a.) and b.) reveals a multidirectional female terminal (100) with threaded holes (110) that is coupled to a first connector (200b) that has a first cylindrical portion (201) with at least one thread on its inner or outer surface; the cylindrical portion (201) extends towards an intermediate base (210) that extends towards a substantially flat extension (203), which allows coupling to another substantially flat extension (203) of a second connector (200b); the extension (203) extends to an intermediate base (210) that extends towards a first cylindrical portion (201) with at least one thread on its inner or outer surface; in the cylindrical portion (201) the thread on the outer surface (2011) and a thread on the inner surface (2012) are shown by way of example; this form is generalized for the entire disclosed invention; the coupling between the extensions (203) of the two connectors (200b) is achieved by a fastening means, such as a screw and nut (not shown in the figure).

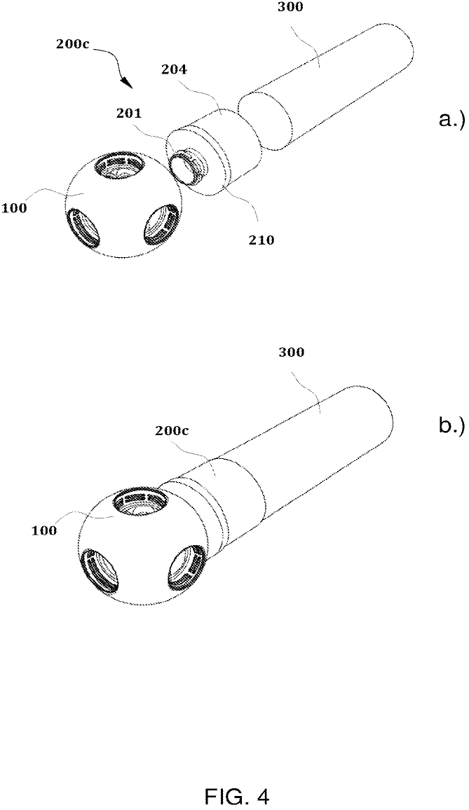

FIG. 4 parts a.) and b.) reveals a multidirectional female terminal (100) coupled to a connector (200c); the connector (200c) is coupled to an extender (300) by fastening means such as screw and nut (not shown in the figure); the connector (200c) has a first cylindrical portion (201) with at least one thread on its inner or outer surface; the cylindrical portion (201) extends towards an intermediate base (210) which extends towards a second cylindrical portion (204) which is substantially smooth on its inner and outer surfaces.

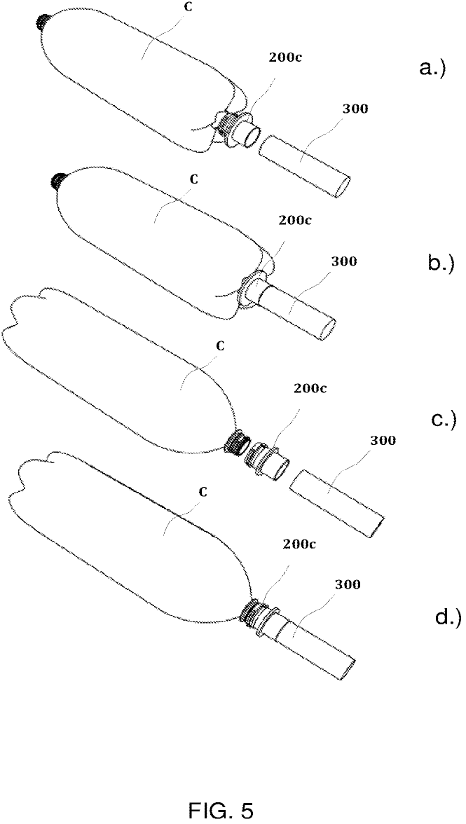

FIG. 5, parts a.) and b.) reveals the form of assembly of a container (C) at the end of the base, where a hole is made that allows the threading of the connector (200c) in its first cylindrical portion with at least one thread that would be of the external type, FIG. 5, parts c.) and d.) reveals the assembly form of a container (C) by the end of the opening, where a direct coupling to the connector (200c) in its first cylindrical portion with at least one thread that would be internal; In addition, an extender (300) connected to a second cylindrical portion of the connector (200c) that is substantially smooth on its inner and outer surfaces is assembled.

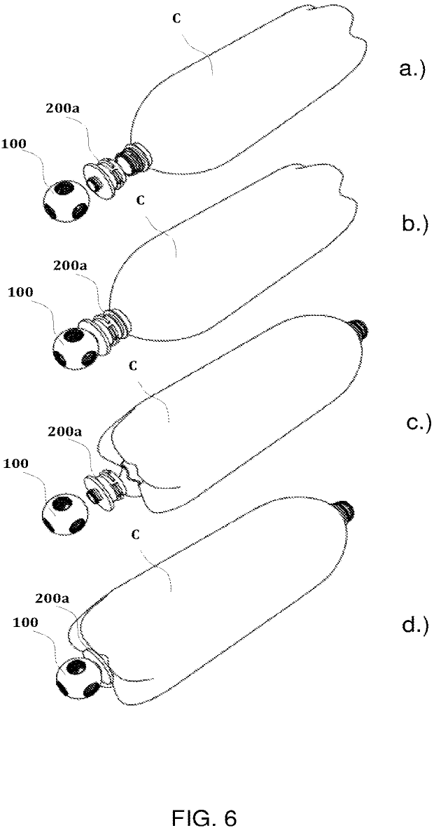

FIG. 6, parts a.) and b.) reveals the form of assembly of a container (C) at the end of the opening, where a direct coupling is made to the connector (200a) in its first cylindrical portion with at least one thread that would be of the internal type, and a coupling of the second cylindrical part with at least one thread that would be of the external type to a multidirectional female terminal (100). FIG. 6, parts c.) and d.) reveals the form of assembly of a container (C) at the end of the base, where a hole is made that allows the threading of the connector (200a) in its first cylindrical portion with at least one thread that would be external; In addition, a multidirectional female terminal (100) connected by a second cylindrical portion that has an external thread on its connector surface (200a) is assembled.

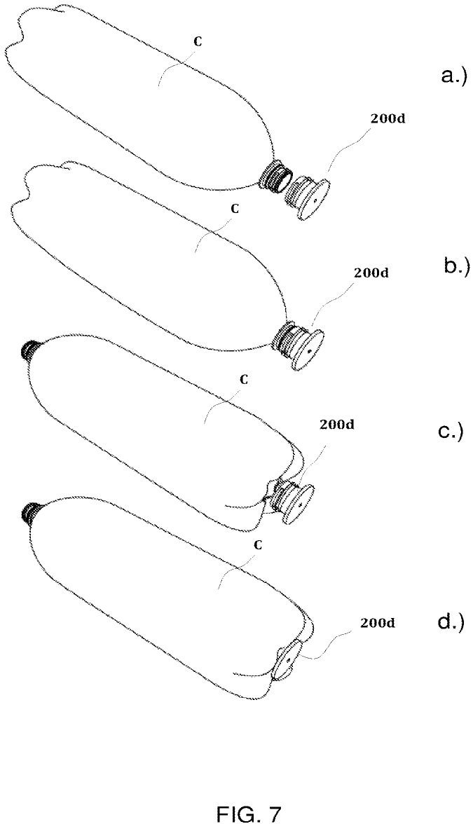

FIG. 7, parts a.) and b.) reveals the form of assembly of a container (C) at the end of the opening, where a direct coupling is made to the connector (200d) in its first cylindrical portion with at least one thread that would be internal. FIG. 7, parts c.) and d.) reveals the form of assembly of a container (C) at the end of the base, where a hole is made that allows the threading of the connector (200d) in its first cylindrical portion with at least one thread that would be external; where the connector (200d) has a first cylindrical portion with at least one thread; where the first cylindrical portion extends to an intermediate base that is flat and does not have a second cylindrical portion.

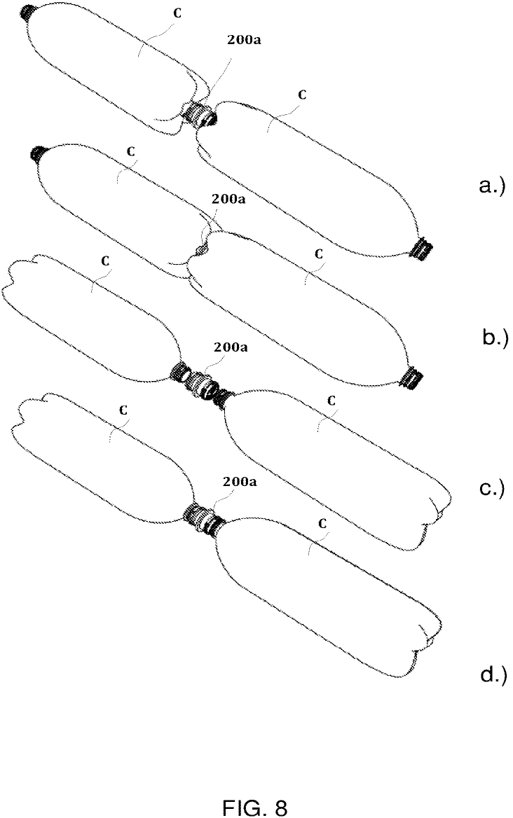

FIG. 8, parts a.) and b.) reveals the form of assembly between two containers (C) at the end of the base, where a hole is made in the bases of the containers (C) that allows the threading of the connector (200a) in its first cylindrical portion with at least one thread that would be of the external type and with the second cylindrical portion with at least one thread that would be of the external type. FIG. 8, parts c.) and d.) reveals the form of assembly of two containers (C) at the end of the opening, where a direct coupling is made to the connector (200a) in its first cylindrical portion with at least one thread that would be of the internal type and with the second cylindrical portion with at least one thread that would be of the internal type.

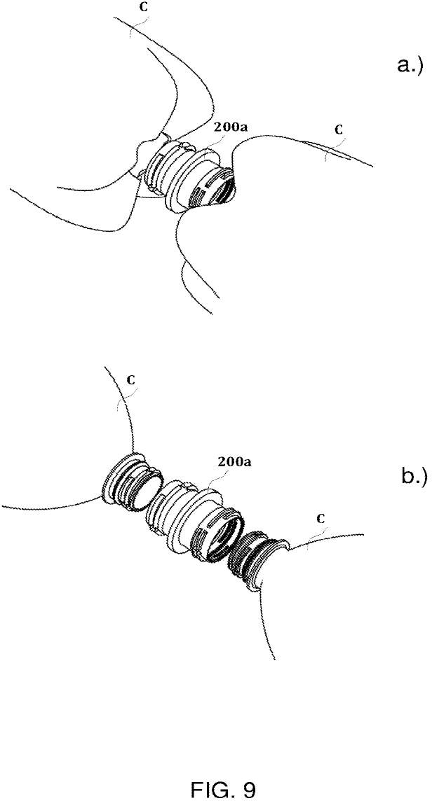

FIG. 9 part a.) reveals the detail of FIG. 8 in part a.) and FIG. 9 part b.) reveals the detail of FIG. 8 in part c.).

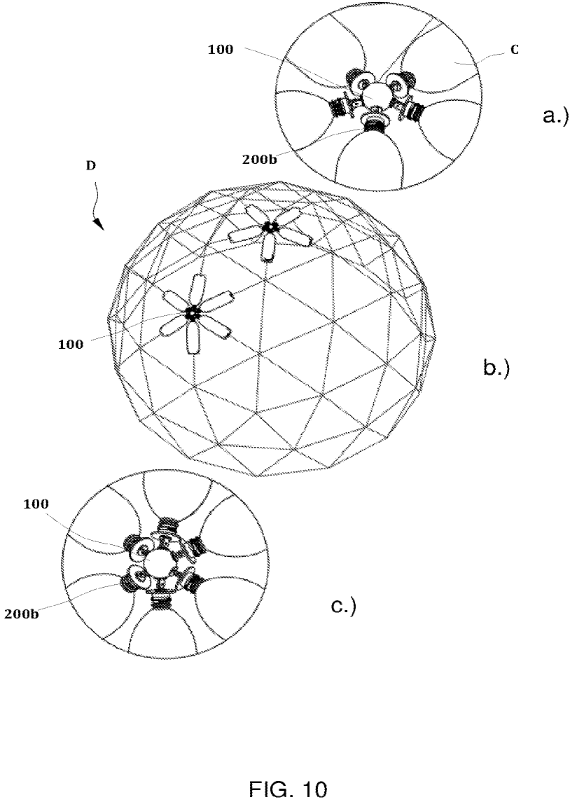

FIG. 10, part b) reveals a geodesic dome with an assembly with multidirectional female terminals (100) and parts a.) and c.) reveal details of the assembly form of each multidirectional female terminal (100) connected to the connectors (200b).

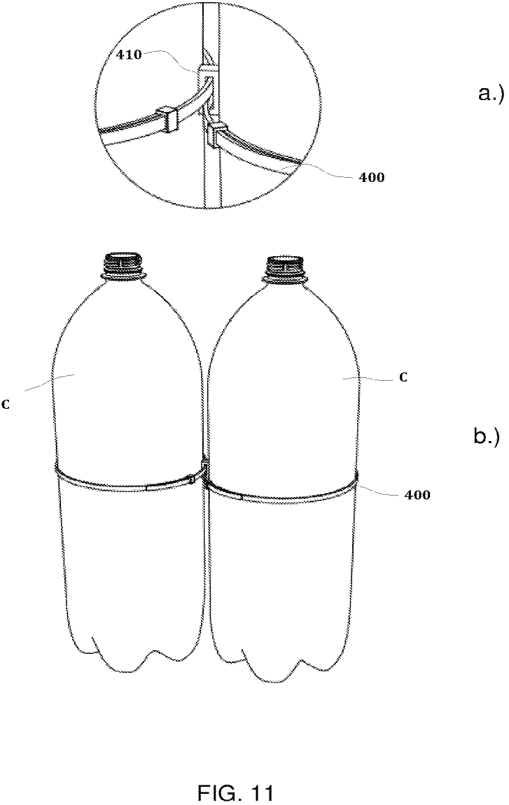

FIG. 11 part a.) reveals a detail of the form of fastening by means of ties (400) and ring (410) to hold containers (C) as shown in part b.).

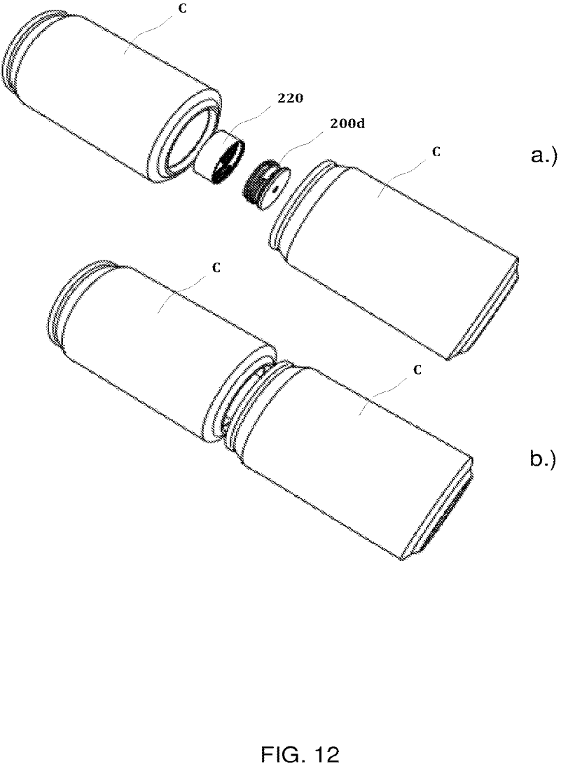

FIG. 12 parts a.) and b.) reveals the form of connection between non-threaded containers (C), where a male or externally threaded connector (200d) is coupled to a female connector (220), with internal thread; where the female connector (220) is fixed to the base of the container (C) for example by means of a rivet and in the same way the connector (200d) is fixed, for example by means of a rivet, to the container (C) in the base or lid as appropriate in each application.

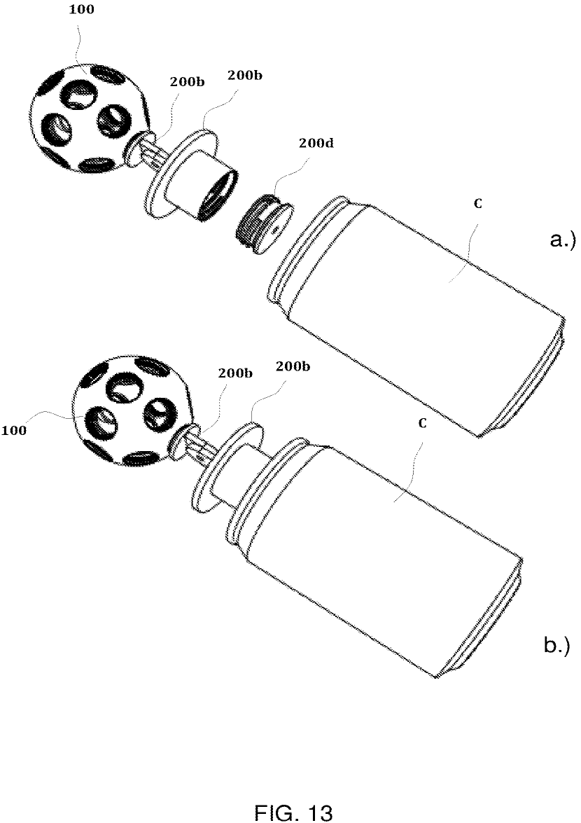

FIG. 13 parts a.) and b.) reveals the form of connection to a non-threaded container (C), where a male or externally threaded connector (200d) is attached to a first connector (200b) with a first part having an internal thread; where the female connector (200d) is fixed to the lid of the container (C) for example by means of a rivet; the first connector (200b) is connected to a second connector (200b) and this to a multidirectional female terminal (100).

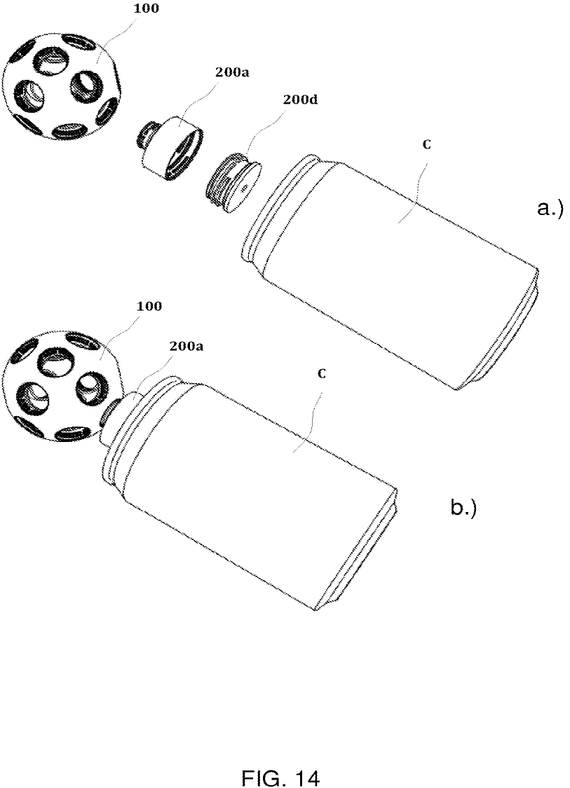

FIG. 14 parts a.) and b.) reveals the form of connection to a non-threaded container (C), where a male or externally threaded connector (200d) is attached to a connector (200a) with a first part having an internal thread; where the female connector (200d) is fixed to the lid of the container (C) for example by means of a rivet; the connector (200a) is connected to a multidirectional female terminal (100), by means of threading.

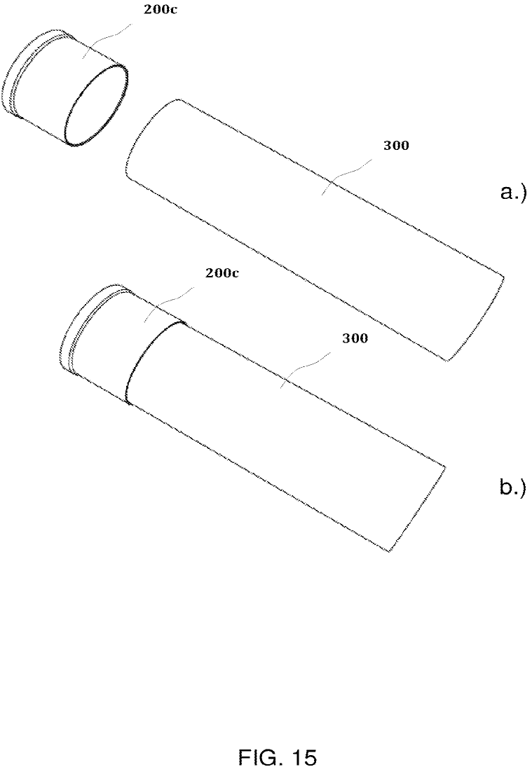

FIG. 15 parts a.) and b.) reveals a coupling of a connector (200c) to an extender (300) by screw and nut fastening means (not shown).

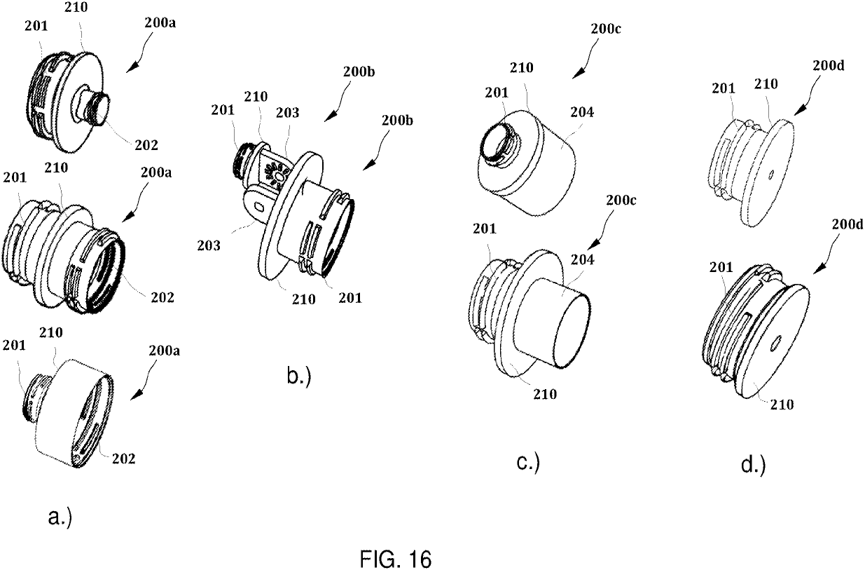

FIG. 16 reveals various embodiments of the connector (200) in its variants (200a) (200b) (200c) (200d) where part a.) it reveals three embodiments of the connector (200a), part b.) reveals an embodiment of the connector (200b), part c.) reveals two embodiments of the connector (200c) and part d.) reveals two embodiments of the connector (200d).

The threads of the connectors (200a) (200b) (200c) (200d) can be left or right as considered in each particular design.

Intermediate base (210) may have a substantially hexagonal or other shape on its outer surface.

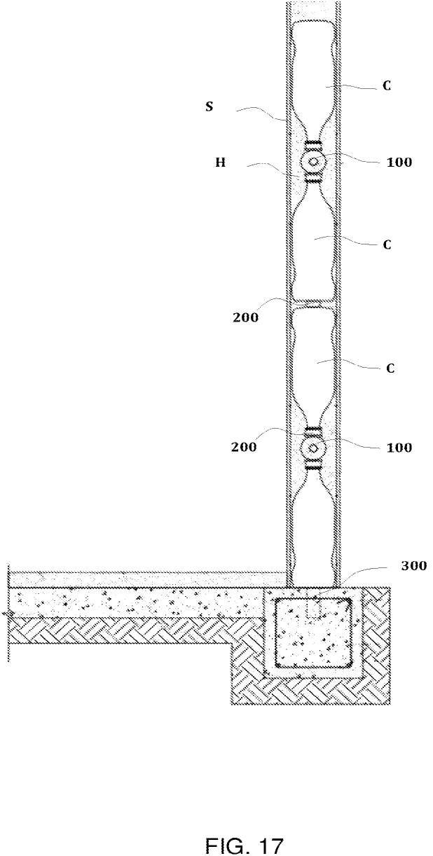

FIG. 17 reveals an arrangement of the omnidirectional construction system in an example of a wall, where the containers (C) are coupled in an orderly manner with multidirectional female terminals (100) having connectors (200) and extenders (300) to form a structure that is covered with concrete (H) or another material that hardens when it dries, and it also has a surface finish layer (S). The wall can also be hollow, that is, with superficial sheets like drywall, and with a filler such as fiberglass or an insulating type.

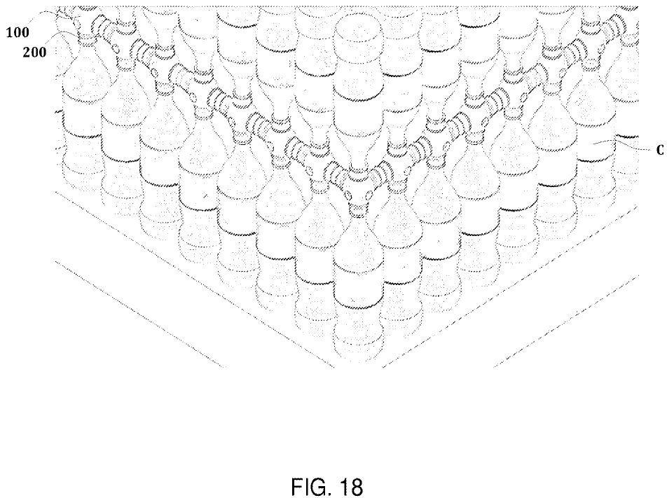

FIG. 18 reveals an arrangement of containers (C), connected by means of multidirectional female terminals (100) and connectors (200).

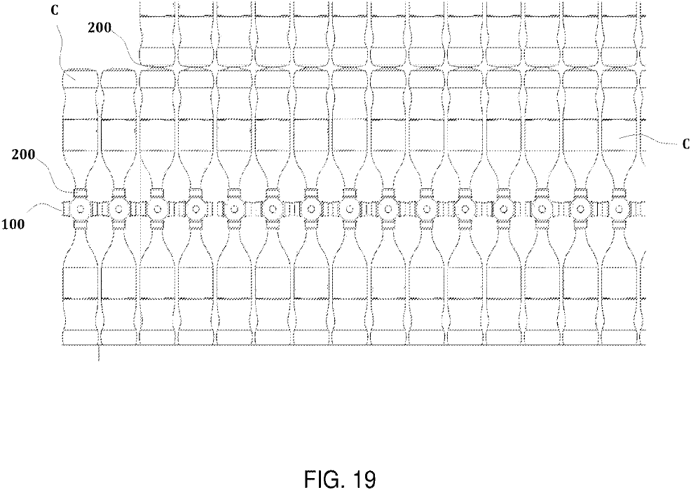

FIG. 19 reveals an arrangement of containers (C), connected by means of multidirectional female terminals (100) and connectors (200), forming a wall-like base structure.

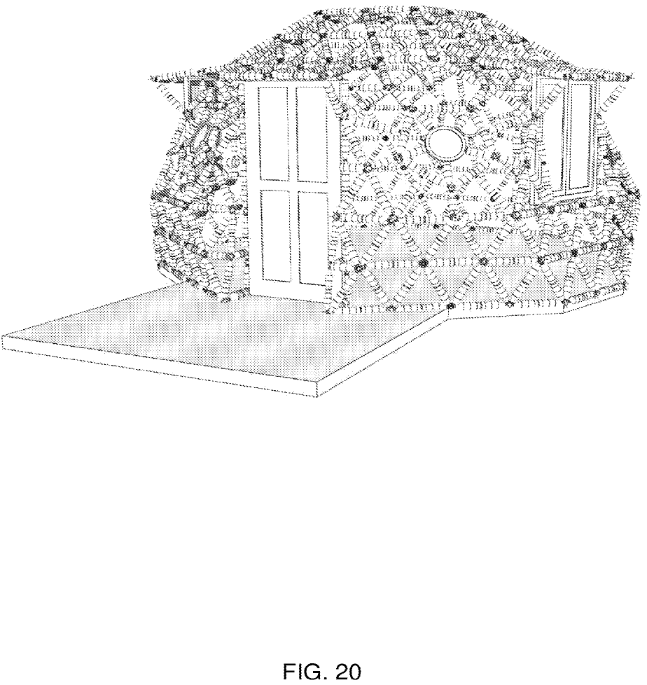

FIG. 20 reveals a layout of a geodesic dome in isometric view, formed from the omnidirectional construction system.

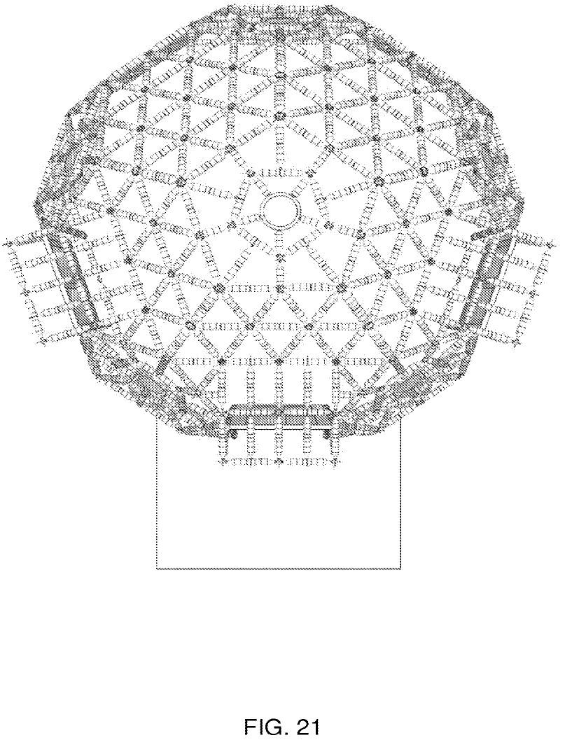

FIG. 21 reveals a layout of a geodesic dome in its plan view, formed from the omnidirectional construction system.

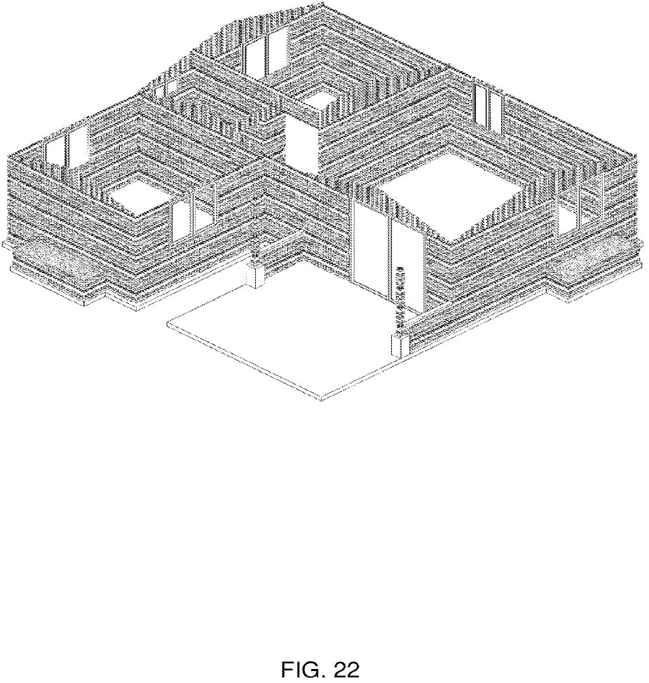

FIG. 22 reveals a wall layout in a living space in its isometric view, formed from the omnidirectional construction system, where it is possible to form walls, ceilings, and locate various configurations according to the connectors disclosed in this invention.

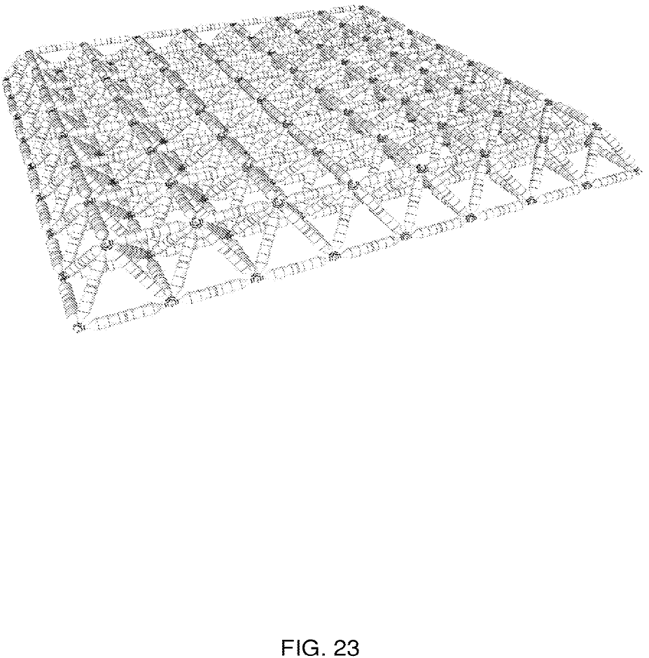

FIG. 23 discloses an exemplary truss structure arrangement.

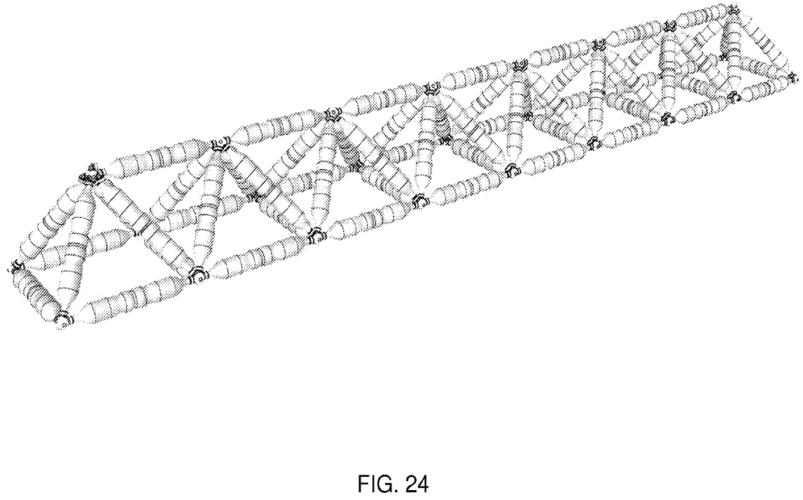

FIG. 24 discloses an arrangement of a truss.

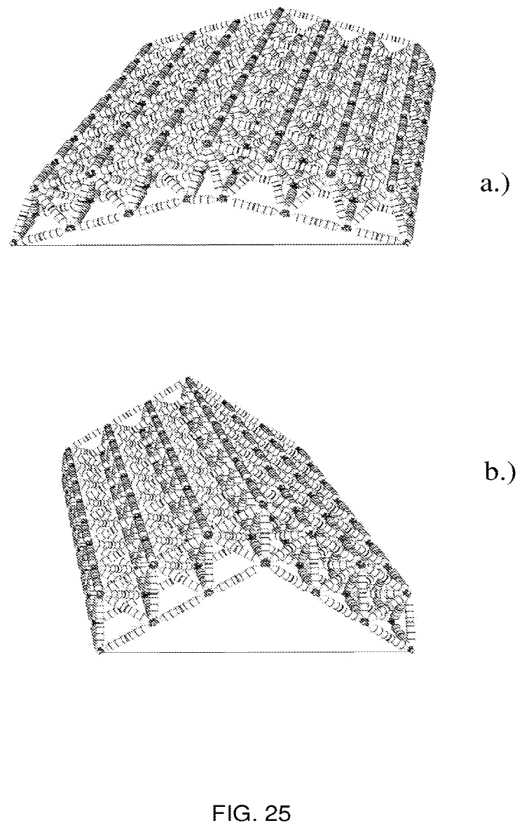

FIG. 25 reveals an arrangement of roof structures, in various geometries.

The possible applications are habitable to multiple use spaces, geodesic structures, domes, furniture of all kinds, planters, rafts and floating structures, portals - covers, gazebos, railings, fences, divisions for cattle, chickens, pigs, retaining walls, covers, toys, sculptures and works of art, decorative partitions, patio umbrellas, bleachers, vertical and inclined gardens, terraces, Christmas trees, floating buoys, structural trusses, three-dimensional structures and/or platforms.

The materials of the terminals (100), connectors (200), and extenders (300) may be selected from plastics, metals, and non-metals.

The above description can only be taken as a reference and not limiting its components or their explicit relationship, but rather they have been described to provide a clear idea about the general conformation of the subject matter of the claimed invention.

What is claimed is:

1. An omnidirectional constructive system that comprises the following:
At least one container;
It is attached by connectors to multidirectional female terminals with threaded holes;
The connectors have a first cylindrical portion with at least one thread on the inside or outside surface and;
The first cylindrical portion extends towards an intermediate base.

2. According to claim 1, at least one connector also has a second cylindrical portion with at least one thread in its inside or outside surface.

3. According to claim 1, at least one connector has the intermediate base substantially flat.

4. According to claim 1, at least one connector has a second cylindrical portion without thread on its inside or outside surface.

5. According to claim 1, at least one connector has a second portion with a substantially flat extension.

6. According to claim 5, at least one connector has a substantially flat extension that can be attached with fastening means such as, screws and nuts, to another connector that has another flat extension.

7. According to claim 1, such multidirectional female terminal has the longitudinal axles of the threaded holes threaded perpendicularly to the planes tangent to a reference sphere.

8. According to claim 7, such tangent planes are orthogonal and oblique between them.

9. According to claim 4, the second cylindrical portion of the connector is attached to an expander.

10. According to claim 1, the systems has fastening means such as ties and rings between the containers.

11. According to claim 1, at least one connector is threaded to the base of a connector.

12. According to claim 1, at least one connector is threaded to a connector opening.

13. According to claim 3, at least one connector with the intermediate flat base is attached to a container with a rivet.

14. According to claim 13, at least one connector with said flat intermediate base is attached to a connector with a threaded portion inside.

15. According to claim 9, the second cylindrical portion of the connector attaches to an expander by means of nut and screw.

16. According to claim 1, it is coated with concrete.

17. According to claim 1, it is contained between two plates.

18. According to claim 1, the system has left or right thread.

19. The system of claim 1, wherein system is used in living spaces and multiple use spaces, geodesic structures, domes, furniture, planters, rafts and floating structures, portals, doors, kiosks, fences, railings, livestock, poultry, pork divisions, contention walls, covers, toys, sculptures, and artworks, decorative partitions, patio umbrellas, stairs, vertical or sloped gardens, terraces, Christmas trees, floating buoys, structural trusses, tridimensional structures and/or platforms.
